(19) United States
(12) Patent Application Publication
(10) Pub. No.: US 2026/0256062 A1
(43) Pub. Date: Sep. 3, 2026

(54) Small Enclosure-type Branch Binding Machine

(71) Applicant: SHENZHEN HUAYOU AGRICULTURAL TECHNOLOGY CO., LTD., Shenzhen (CN)

(72) Inventor: Yong LIU, Shenzhen (CN)

(21) Appl. No.: 19/659,615

(22) Filed: Apr. 27, 2026

Related U.S. Application Data
(63) Continuation of application No. PCT/CN2024/124167, filed on Oct. 11, 2024.

(30) Foreign Application Priority Data
Oct. 29, 2023 (CN) 202311411160.0

(51) Int. Cl. A01G 17/08; B65B 13/02; B65B 13/18

(52) U.S. Cl. CPC A01G 17/08; B65B 13/025; B65B 13/185

(57) ABSTRACT

The present invention relates to a small enclosure-type branch binding machine comprising a clamping device, a bow-shaped frame, a handle, a machine frame, a needle box and a strap box. The handle and bow-shaped frame are hinged on the machine frame in an "X" shape. The clamping device at the front end of the bow-shaped frame includes a hook head with a pressing block and a top block, equipped with a torsion spring and a compression spring. A single compression spring realizes both driving and locking functions of the hook head, significantly reducing production cost and machine head size while avoiding damage to plants during branch binding.

### CROSS-REFERENCE TO RELATED APPLICATIONS

The present application is a continuation of International Application No. PCT/CN2024/124167, filed on October 11, 2024, which claims priority to Chinese Patent Application No. 202311411160.0, filed on October 29, 2023, the entire disclosure of which is incorporated herein by reference.

### TECHNICAL FIELD

The present invention relates to the technical field of bundling tools for agricultural production, in particular to a small enclosure-type branch binding machine.

### BACKGROUND

When planting crops such as tomatoes, grapes, and kiwifruits, etc., we usually need to fix the vines or branches of the plants on bamboo poles or iron wires to guide their growth or assist in fruiting, improving the yield and quality of the crops; to improve the branch binding efficiency, compared with the traditional use of ropes for branch binding, operators now usually use branch binding machines (also known as bundling machines) to bundle and fix the plants.

For example, CN107517773A discloses a branch binding machine, which includes a holding member, a holding member force application unit, a locking member, and a locking member force application unit. The holding member force application unit is a torsion spring that applies a force with a counterclockwise rotation trend to the holding member, and the locking member is engaged with the holding member to keep the holding member in the standby position; the locking member force application unit is a compression spring that applies a force with a clockwise rotation trend to the locking member.

CN211210728U discloses a branch binding machine, which mainly includes a strap clamping device, a bow-shaped frame, a handle, a frame, a needle box, and a strap box. The said locking plate is hinged in the cavity of the enclosure, and a spring that makes it have a counterclockwise rotation trend is arranged on the said locking plate; the said strap pressing needle is hinged in the cavity of the said enclosure, and a torsion spring that makes it have a counterclockwise rotation trend is also arranged on the said strap pressing needle; the said locking plate matches the said strap pressing needle.

However, the branch binding machines in the prior art have the following shortcomings: The size of the machine head is large, so when bundling some dense branches, the machine head is easy to break other non-bundled branches; when bundling flowering plants (e.g., cherry tomatoes), it is easy to knock off the fruit flowers, causing damage to the plants;

the clamping device in the prior art usually includes a holding member (strap pressing needle), a locking member (locking plate), a holding member force application unit and a locking member force application unit. The opening and closing of the holding member are realized based on the mutual transmission relationship between the locking member and the holding member. Due to the complex structure of the above components, there is limited space for optimizing the size of the machine head.

In view of the above shortcomings of the prior art, the purpose of the present invention is to provide a small enclosure-type branch binding machine, which can realize the opening and closing of the hook head by only setting one torsion spring. Compared with the prior art which realizes the opening and closing of the holding mechanism through the transmission of the holding member (strap pressing needle), the locking member (locking plate), and their holding member force application unit and locking member force application unit, the present invention has a simple structure and ingenious layout, and the protruding size of the machine head is significantly reduced.

### SUMMARY OF THE INVENTION

The present invention provides a small enclosure-type branch binding machine, which solves the technical problem that the length of the machine head in the prior art is too long, which is easy to cause damage to plants.

The solution of the present invention to the above technical problems is as follows: A small enclosure-type branch binding machine, comprising a clamping device, a bow-shaped frame, a handle, a frame, a needle box and a strap box, of which the rear end of the bow-shaped frame is hinged on the frame, and a handle is arranged between the bow-shaped frame and the frame. The handle and the bow-shaped frame are hinged on the frame in an "x" shape; a clamping device is arranged at the front end of the bow-shaped frame, which can clamp the strap from the front end of the frame, and the clamping device includes: an enclosure, a torsion spring, a hook head, a strap clamping plate, a forming anvil and a compression spring. The hook head is hinged in the cavity of the enclosure, and connected with a torsion spring and a compression spring that make it have a clockwise movement trend. The forming anvil is arranged at the lower end of the enclosure, and the strap clamping plate is arranged between the hook head and the forming anvil;

the upper part of the hook head is provided with a positioning groove and a compression spring positioning head, and the lower end of the compression spring is sleeved on the compression spring positioning head. The end of the torsion spring is inserted into the positioning groove to lock the hook head.

Preferably, the hook head includes a pressing block, a strap grabbing groove, a positioning groove, a top block and a compression spring positioning head. The bottom of the hook head is provided with a strap grabbing groove; the left side of the hook head is provided with a pressing block; the right side of the hook head is provided with the top block, of which the strap grabbing groove is matched with the strap clamping plate.

Preferably, the front end of the frame is provided with a cutter and an impact block, of which the cutter is fixedly connected with the frame, and the impact block is hinged with the frame; the impact block is matched with the pressing block and the top block on the hook head; the strap passes through the impact block. When the bow-shaped frame rotates relative to the frame in the closing direction, the impact block contacts the pressing block to make the end of the torsion spring disengage from the positioning groove, releasing the locked state of the hook head; when the bow-shaped frame rotates relative to the frame in the closing direction again, the impact block contacts the top block to make the end of the torsion spring snap into the positioning groove, completing the locking of the hook head.

Preferably, the upper part of the said compression spring is arranged in a compression spring energy storage groove, and the compression spring energy storage groove is fixedly arranged in the cavity of the enclosure.

Preferably, the positioning groove is arc-shaped, and the compression spring positioning head is long strip-shaped. The cross-section of the compression spring energy storage groove is a U-shaped groove.

Preferably, spherical protrusions are arranged on the surface of the strap clamping plate, and concave-convex patterns are set on the surface of the strap grabbing groove. The strap grabbing groove at the bottom of the hook head is matched with the spherical protrusions.

Preferably, the front end of the needle box is provided with a needle outlet, and the bottom of the needle outlet is provided with a needle pressing head. A spring is arranged between the lower surface of the needle box and the frame, and the rear end of the needle box is hinged with the frame. The forming anvil of the clamping device is matched with the needle outlet.

Preferably, the handle is composed of a handle skeleton and a plastic grip, and the handle skeleton is embedded in the plastic grip.

Preferably, a silica gel anti-slip pad is arranged on the upper surface of the plastic grip.

A first pin is arranged at the rear part of the frame, and a third pin is arranged in the middle part of the frame. The bottom of the bow-shaped frame is hinged with the frame through the first pin; a second pin is arranged in the middle part of the bow-shaped frame, and the upper part of the handle skeleton is hinged with the bow-shaped frame through the second pin. A first hook body is arranged at the lower end of the handle skeleton, and the first hook body is sleeved on the outer circumference of the third pin.

The beneficial effects of the present invention are as follows: The small enclosure-type branch binding machine provided by the present invention has the following advantages:
1. A positioning groove is arranged on the top of the hook head; a first hinge shaft and a second hinge shaft are fixedly arranged in the cavity of the enclosure; a torsion spring is fixedly sleeved on the first hinge shaft; the hook head is rotatably sleeved on the second hinge shaft. When one end of the torsion spring is snapped into the positioning groove, a triangular structure is formed by the three points of the positioning groove, the first hinge shaft and the second hinge shaft, and the torsion spring can reliably lock the hook head.
2. The hook head includes a pressing block and a top block, of which the pressing block is arranged on the left side of the hook head, and the top block is arranged on the right side of the hook head. When grabbing the strap, the impact block contacts the pressing block to make the hook head rotate clockwise and close; when cutting the strap, the impact block contacts the top block to make the hook head rotate counterclockwise until the end of the torsion spring is inserted into the positioning groove to lock the hook head. The single compression spring structure realizes the driving and locking functions of the hook head. Compared with the prior art which is provided with a holding member and a locking member, the structure is simpler and the layout is more ingenious, so that the width dimension of the machine head is significantly reduced, and the production and manufacturing cost and component cost are significantly reduced.
3. To improve the grabbing force of the hook head when grabbing the strap, the hook head is also connected with a compression spring that makes it have a clockwise movement trend. When the hook head rotates clockwise, the pressing force of the hook head on the strap clamping plate is increased under the action of the compression spring, further improving the grabbing force on the strap when the strap grabbing groove is matched with the spherical protrusion.

The above description is only an overview of the technical solution of the present invention. To understand the technical means of the present invention more clearly and implement it according to the content of the specification, a detailed description with the preferred embodiments of the present invention and the drawings are present as follows. The specific implementation of the present invention is given in detail by the following embodiments and their drawings.

### BRIEF DESCRIPTION OF THE DRAWINGS

The drawings described here are used to provide a further understanding of the present invention and form a part of the present invention. The schematic embodiments of the present invention and their descriptions are used to explain the present invention and do not constitute an improper limitation of the present invention. Among all drawings:

FIG. 1 is a front view of the branch binding machine, which is a structural schematic diagram of the bow-shaped frame in the open position.

FIG. 2 is a front view of the branch binding machine, which is a structural schematic diagram of the bow-shaped frame in the predetermined position.

FIG. 3 is a front view of the clamping device, which is a structural schematic diagram of the clamping mechanism in the standby state.

FIG. 4 is a front view of the clamping device, which is a structural schematic diagram of the clamping mechanism in the strap grabbing state.

FIG. 5 is a front view of the hook head of the clamping device.

FIG. 6 is a front view of the branch binding machine, which is a cross-sectional view of the bow-shaped frame in the closed position.

FIG. 7 is a front view of the branch binding machine, which is a cross-sectional view of the bow-shaped frame in the open position after grabbing the strap.

FIG. 8 is a front view of the branch binding machine, which is a cross-sectional view of the branch binding state after the bow-shaped frame grabs the strap.

FIG. 9 is a front view of the branch binding machine, which is a cross-sectional view of the binding and cutting state after the bow-shaped frame grabs the strap.

FIG. 10 is a structural schematic diagram comparing the head sizes between the branch binding machine of the present invention and the branch binding machine of the prior art.

In the drawings, the list of components represented by each label is as follows:

1. Clamping device; 11. Enclosure; 12. Torsion spring; 13. Hook head; 131. Pressing block; 132. Strap grabbing groove; 133. Positioning groove; 134. Top block; 135. Compression spring positioning head; 14. Hook head; 15. Forming anvil; 16. Compression spring; 161. Compression spring energy storage groove;

2. Bow-shaped frame; 21. Bow plate; 22. Bracket;

3. Handle; 31. Handle skeleton; 311. First hook body; 32. Plastic grip;

4. Frame; 41. Cutter table; 411. Cutter; 412. Impact block;

5. Needle box; 51. Needle outlet; 52. Spring; 53. Needle pressing head;

6. Strap box;

71. First pin shaft; 72. Second pin shaft; 73. Third pin shaft;

A1. First hinge shaft; A2. Second hinge shaft; TP. Strap.

### DETAILED DESCRIPTION

The principles and features of the present invention will be described below with reference to the drawings 1-10. The embodiments given are only used to explain the present invention and are not used to limit the scope of the present invention. The present invention will be described more specifically by way of examples with reference to the drawings in the following paragraphs. The advantages and features of the present invention will become clearer according to the following description and claims. It should be noted that the drawings are in a very simplified form and use non-precise scales, which are only used to conveniently and clearly assist in explaining the purpose of the embodiments of the present invention.

It should be noted that when a component is referred to as being "fixed" to another component, it can be directly fixed to the other component or there may be an intermediate component. When a component is considered to be "connected" to another component, it can be directly connected to the other component or there may be an intermediate component. When a component is considered to be "arranged" on another component, it can be directly arranged on the other component or there may be an intermediate component. The terms "vertical", "horizontal", "left", "right" and similar expressions used herein are for illustrative purposes only.

Unless otherwise defined, all technical and scientific terms used herein have the same meaning as commonly understood by those skilled in the technical field of the present invention. The terms used in the specification of the present invention herein are only for the purpose of describing specific embodiments, and are not intended to limit the present invention. The term "and/or" used herein covers any and all combinations of one or more listed items concerned.

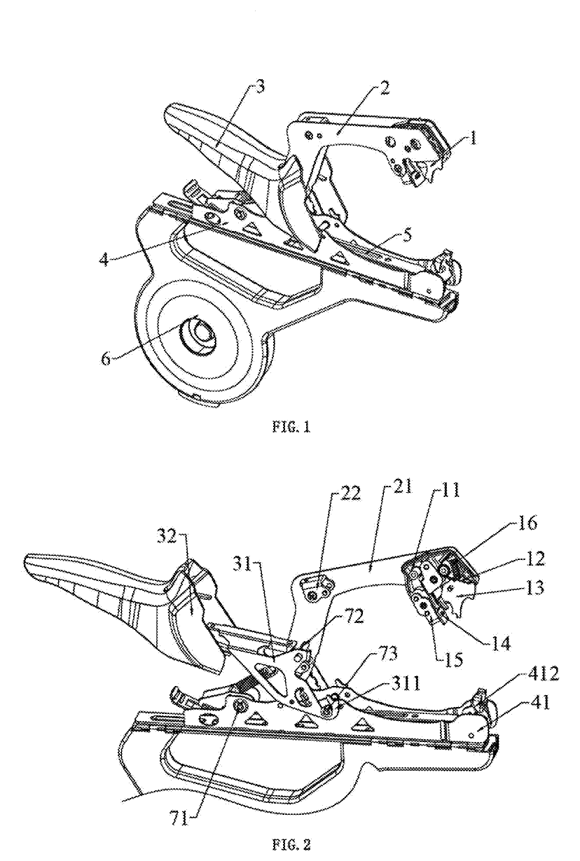

As shown in FIGS. 1-2, a small enclosure-type branch binding machine provided in an embodiment of the present invention includes a clamping device 1, a bow-shaped frame 2, a handle 3, a frame 4, a needle box 5 and a strap box 6. The frame 4 is linear and has a "U"-shaped cross-section; the bow-shaped frame 2 is arc-shaped, and its rear end is hinged on the frame 4. A handle 3 is arranged between the bow-shaped frame 2 and the frame 4, and the handle 3 and the bow-shaped frame 2 are hinged on the frame 4 in an "x" shape; a clamping device 1 is arranged at the front end of the bow-shaped frame 2;

The handle 3 is composed of a handle skeleton 31 and a plastic grip 32. The said handle skeleton 31 is embedded in the said plastic grip 32. To improve the gripping friction, a silica gel anti-slip pad is arranged on the upper surface of the plastic grip 32, and the anti-slip pad can be made of silica gel;

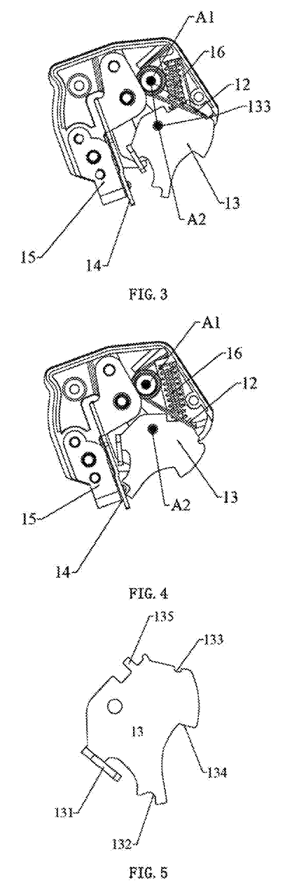

A first pin 71 is arranged at the rear part of the said frame 4, and a third pin 73 is arranged in the middle part of the frame 4. The bottom of the bow-shaped frame 2 is hinged with the frame 4 through the said first pin 71; a second pin 72 is arranged in the middle part of the said bow-shaped frame 2, and the upper end of the said handle skeleton 31 is hinged with the said bow-shaped frame 2 through the said second pin 72. A first hook body 311 is arranged at the lower end of the handle skeleton 31, and the first hook body 311 is hung on the outside of the third pin 73. The said first hook body 311 is sleeved on the outer circumference of the said third pin 73; a pull ring is arranged between the handle skeleton 31 and the frame 4, so that the bow-shaped frame 2 and the frame 4 have a movement trend of separating from each other. As shown in FIG. 1, when there is no external force, the bow-shaped frame 2 remains in the open position relative to the frame 4; as shown in FIG. 3, when the handle 3 is pressed, the bow-shaped frame 2 rotates relative to the frame 4, so that the front end of the bow-shaped frame 2 contacts the frame 4, which is the closed position of the bow-shaped frame 2 at this time.

As shown in FIGS. 2-5, the clamping device 1 is installed at the front end of the bow-shaped frame 2. The clamping device 1 includes an enclosure 11, a torsion spring 12, a hook head 13, a strap clamping plate 14 and a forming anvil 15. The enclosure 11 is a cavity structure, and the torsion spring 12, the hook head 13, the strap clamping plate 14 and the forming anvil 15 are all arranged in the cavity of the enclosure 11. The said hook head 13 is hinged in the cavity of the said enclosure 11, and the said hook head 13 is also connected with a torsion spring 12 that makes it have a clockwise movement trend.

The forming anvil 15 is arranged at the lower end of the said enclosure 11, and the said strap clamping plate 14 is arranged between the said hook head 13 and the forming anvil 15; the hook head 13 includes a pressing block 131, a strap grabbing groove 132, a positioning groove 133 and a top block 134. The strap grabbing groove 132 is set at the bottom of the hook head 13, and the pressing block 131 is arranged on the left side of the hook head. The top block 134 is arranged on the right side of the hook head 13. A first hinge shaft A1 and a second hinge shaft A2 are fixedly arranged in the cavity of the enclosure 11, and the torsion spring 12 is fixedly sleeved on the first hinge shaft A1. The hook head 13 is rotatably sleeved on the second hinge shaft A2. When one end of the torsion spring 12 is snapped into the positioning groove 133, a triangular structure is formed by the three points of the positioning groove 133-A1-A2; when the end of the torsion spring 12 is inserted into the positioning groove 133, the hook head 13 can be locked.

The hook head 13 contacts the strap clamping plate 14 to realize the strap grabbing action. To improve the friction force when the hook head 13 grabs the strap, spherical protrusions are arranged on the surface of the strap clamping plate 14, and concave-convex patterns are set on the surface of the strap grabbing groove 132. When the strap grabbing groove 132 at the bottom of the hook head 13 is matched with the said spherical protrusions, the grabbing force on the strap can be improved.

To improve the grabbing force of the hook head 13 when grabbing the strap, the hook head 13 is also connected with a compression spring 16 that makes it have a clockwise movement trend. The upper part of the compression spring 16 is arranged in a compression spring energy storage groove 161, and the cross-section of the compression spring energy storage groove 161 is a U-shaped groove fixed in the cavity of the enclosure 11; the compression spring energy storage groove 161 is used to fix the contracted compression spring 16 and store the energy of the compression spring 16. When the hook head 13 rotates clockwise, the pressing force of the hook head 13 on the strap clamping plate 14 is increased under the action of the compression spring 16, further improving the grabbing force on the strap when the strap grabbing groove 132 is matched with the said spherical protrusions.

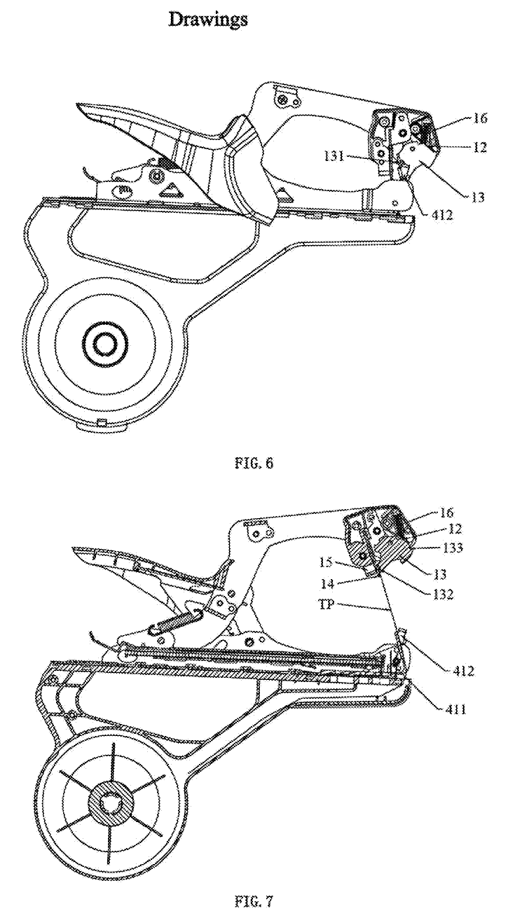

As shown in FIGS. 6-9, the front end of the frame 4 is provided with a cutter 421 and an impact block 422. The said cutter 421 is fixedly connected with the said frame 4, and the said impact block 422 is hinged with the said frame 4; the said impact block 422 is matched with the pressing block 131 and the top block 134 on the said hook head 13;

The strap TP is led out from the strap box 6 and passes through the impact block 422. When the bow-shaped frame 2 rotates relative to the frame 4 in the closing direction, the impact block 422 contacts the pressing block 131 to make the hook head 13 rotate clockwise, making the end of the said torsion spring 12 disengage from the said positioning groove 133 and releasing the locked state of the hook head 13; when the bow-shaped frame 2 rotates relative to the frame 4 in the closing direction again, the said impact block 422 contacts the said top block 134 to make the end of the torsion spring 12 snap into the positioning groove 133, completing the locking of the said hook head 13.

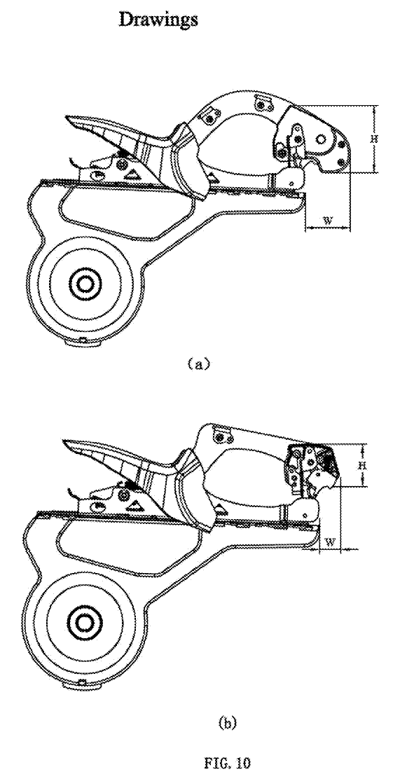

As shown in FIG. 10, Figure a is the branch binding machine of the prior art; Figure b is the branch binding machine of the present invention; W is the protruding width of the machine head; H is the height of the machine head; since the clamping device in the prior art usually includes a holding member, a holding member force application unit, a locking member, and a locking member force application unit. The holding member force application unit is a torsion spring that applies a force with a counterclockwise rotation trend to the holding member, and the locking member is engaged with the holding member to keep the holding member in the standby position; the locking member force application unit is a compression spring that applies a force with a clockwise rotation trend to the locking member. The above structure has many parts, resulting in a large protruding width and height of the machine head, and limited adjustable space. The present invention is to set a positioning groove on the top of the hook head. When one end of the torsion spring is snapped into the positioning groove, the torsion spring can reliably lock the hook head; when binding branches, the impact block makes the hook head rotate clockwise, and the end of the torsion spring slides out of the positioning groove. The torsion spring gives the hook head a clockwise rotation trend, and acts as the holding member force application unit and the locking member. Compared with the prior art which is provided with a holding member and a locking member, the structure is simpler and the layout is more ingenious. It can be seen from the comparison of Figures a and b that compared with the machine head size of the prior art, the protruding width W and height H of the machine head of the present invention are significantly reduced.

In addition, the front end of the needle box 5 is provided with a needle outlet 51, the bottom of the needle outlet 51 is provided with a needle pressing head 53. A spring 52 is arranged between the lower surface of the needle box 5 and the frame 4, and the rear end of the said needle box 5 is hinged with the said frame 4. The forming anvil 15 of the clamping device 1 is matched with the needle outlet 51; when the front end of the needle box 5 is subjected to the downward force of the forming anvil 15, it can rotate downward relative to the frame 4, and the needle pressing head 53 pushes out the staples in the needle box 5, and the staples bind the strap under the action of the forming anvil 15 (the binding principle is similar to that of a stapler); after the force disappears,

under the action of the spring 52, the needle box 5 rotates upward relative to the frame 4 to the initial position. Operating Principle:

The branch binding machine includes a standby state, a strap grabbing state, a branch binding state, and a binding and cutting state, which are as follows:

Standby state: As shown in FIGS. 1-3, FIGS. 1-2 are the standby state of the branch binding machine before bundling, of which the position of the bow-shaped frame 2 relative to the frame 1 is the open position, and FIG. 3 is the structural diagram of the clamping device 1 corresponding to the state of FIG. 2. In the standby state, the hook head 13 is in the locked position, and its front end is kept separated from the strap clamping plate 14. The end of the torsion spring 12 is inserted into the positioning groove 133 of the hook head 13.

Strap grabbing state: As shown in FIGS. 4 and 6-7, based on the state shown in FIG. 2, force is applied by pressing the handle 3, and the bow-shaped frame 2 rotates clockwise and downward relative to the frame 4; as shown in FIG. 6, as the bow-shaped frame 2 rotates until the clamping device 1 contacts the front end of the frame 4, the impact block 412 contacts the pressing block 131, and the impact block 412 gives the hook head 13 a clockwise force. The end of the torsion spring 12 slides out of the positioning groove 133 of the hook head 13, and the hook head 13 rotates clockwise under the pressure of the torsion spring 12 and the compression spring 16. At this time, the hook head 13 contacts the strap clamping plate 14, and spherical protrusions are arranged on the surface of the strap clamping plate 14. The spherical protrusions are matched with the strap grabbing groove 132 to realize the clamping of the strap TP.

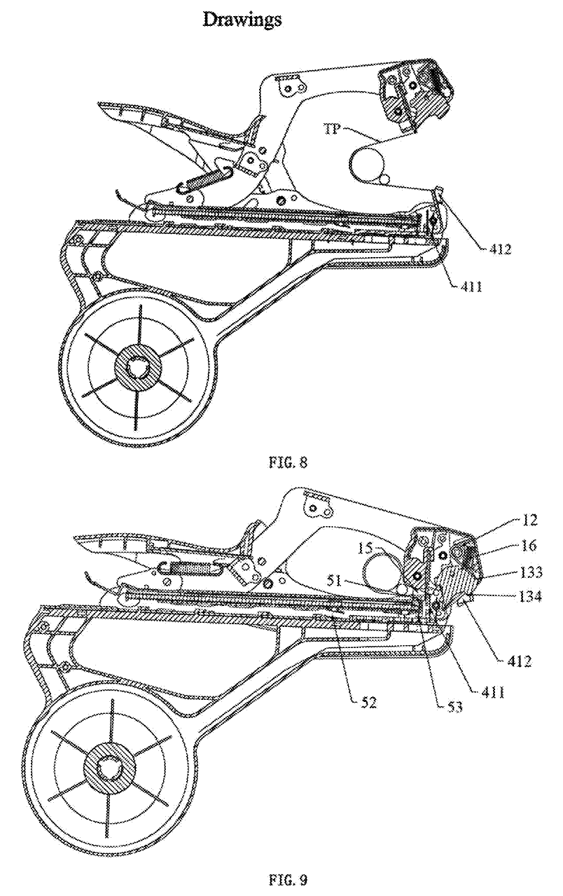

Branch binding state: As shown in FIGS. 7-8, after the hook head 13 clamps the strap TP, the pressing force on the handle 3 is released, and the bow-shaped frame 2 rotates counterclockwise and upward. As the bow-shaped frame 2 rotates, the strap TP is stretched; as shown in FIG. 8, after the branch binding machine is inserted into the position of the branch to be bound, the strap TP is wrapped around the branch to complete the branch binding;

Binding and cutting state: As shown in FIGS. 8-9, after adjusting the strap to a suitable position on the branch, the handle 3 is pressed, at this time, the bow-shaped frame 2 moves downward again until the clamping device 1 contacts the front end of the frame 4. The handle 3 is pressed further, at this time, the forming anvil 15 contacts the front end of the needle box 5. Under the pressing of the forming anvil 15, the needle box 5 rotates downward to make the needle pressing head 53 press the staples out of the needle outlet 51 and contact the forming anvil 15 to complete the binding of the strap TP; additionally, the impact block 412 contacts the lower arc segment of the hook head 13 and rotates clockwise until it contacts the top block 134. As the impact block 412 rotates clockwise, the cutter 411 is exposed, and the cutter 411 cuts the strap TP; subsequently, the impact block 412 continues to press the top block 134 until the end of the torsion spring 12 is snapped into the positioning groove 133 to lock the hook head 13, and the binding and cutting of the strap are completed at this time; then the handle 3 is released, at this time, the bow-shaped frame 2 returns to the open position again, and the hook head 13 returns to the standby state. Now, one branch binding operation is completed. The branch binding operation for various branches can be realized by repeating the above actions.

What needs to be illustrated is that the relational terms (such as "the first" and "the second") herein are only used to distinguish one entity or operation from another, and do not necessarily require or imply that there is any such practical relationship or order between the entity or operation. The content not described in detail in this specification belongs to the prior art known to those skilled in the art.

The above is only a preferred embodiment of the present invention, and is not intended to limit the present invention in any form; all ordinary technicians in the industry can smoothly implement the present invention according to the drawings of the specification and the above description; however, any slight changes, modifications and equivalent changes made by those skilled in the art by using the technical content disclosed above without departing from the scope of the technical solution of the present invention are equivalent embodiments of the present invention; additionally, any equivalent changes, modifications and evolutions made to the above embodiments according to the essential technology of the present invention still fall within the protection scope of the technical solution of the present invention.

What is claimed is:

1. A small enclosure-type branch binding machine, comprising a clamping device (1), a bow-shaped frame (2), a handle (3), a frame (4), a needle box (5) and a strap box (6), of which
the rear end of the bow-shaped frame (2) is hinged on the frame (4), and the handle (3) is arranged between the bow-shaped frame (2) and the frame (4). The handle (3) and the bow-shaped frame (2) are hinged on the frame (4) in an "x" shape; the clamping device (1) is arranged at the front end of the bow-shaped frame (2), and the said clamping device (1) can clamp the strap from the front end of the frame (4), characterized in that the said clamping device (1) comprises:
An enclosure (11), a torsion spring (12), a hook head (13), a strap clamping plate (14), a forming anvil (15) and a compression spring (16). The said hook head (13) is hinged in the cavity of the said enclosure (11) and connected with the torsion spring (12) and the compression spring (16) that make it have a clockwise movement trend. The said forming anvil (15) is arranged at the lower end of the said enclosure (11), and a strap clamping plate (14) is arranged between the said hook head (13) and the forming anvil (15);
the upper part of the said hook head (13) is provided with a positioning groove (133) and a compression spring positioning head (135), and the lower end of the said compression spring (16) is sleeved on the said compression spring positioning head (135). The end of the said torsion spring (12) is inserted into the said positioning groove (133) to lock the said hook head (13).

2. The small enclosure-type branch binding machine according to claim 1, characterized in that the said hook head (13) comprises a pressing block (131), a strap grabbing groove (132), a positioning groove (133), a top block (134) and a compression spring positioning head (135). The bottom of the hook head (13) is provided with a strap grabbing groove (132); the left side of the hook head is provided with a pressing block (131); the right side of the hook head (13) is provided with the top block (134). The said strap grabbing groove (132) is matched with the said strap clamping plate (14).

3. The small enclosure-type branch binding machine according to claim 2, characterized in that the front end of the said frame (4) is provided with a cutter (411) and an impact block (412). The said cutter (411) is fixedly connected with the said frame (4), and the said impact block (412) is hinged with the said frame (4); the said impact block (412) is matched with the pressing block (131) and the top block (134) on the said hook head (13); the strap passes through the said impact block (412). When the bow-shaped frame (2) rotates relative to the said frame (4) in the closing direction, the said impact block (412) contacts the said pressing block (131) to make the end of the said torsion spring (12) disengage from the said positioning groove (133), releasing the locked state of the said hook head (13); when the said bow-shaped frame (2) rotates relative to the said frame (4) in the closing direction again, the said impact block (412) contacts the said top block (134) to make the end of the said torsion spring (12) snap into the said positioning groove (133), completing the locking of the said hook head (13).

4. The small enclosure-type branch binding machine according to claim 3, characterized in that the upper part of the said compression spring (16) is arranged in a compression spring energy storage groove (161), and the said compression spring energy storage groove (161) is fixedly arranged in the cavity of the said enclosure (11).

5. The small enclosure-type branch binding machine according to claim 3, characterized in that the said positioning groove (133) is arc-shaped, and the said compression spring positioning head (135) is long strip-shaped. The cross-section of the said compression spring energy storage groove (121) is a U-shaped groove.

6. The small enclosure-type branch binding machine according to claim 3, characterized in that spherical protrusions are arranged on the surface of the said strap clamping plate (14), and concave-convex patterns are set on the surface of the said strap grabbing groove (132). The strap grabbing groove (132) at the bottom of the hook head (13) is matched with the said spherical protrusions.

7. The small enclosure-type branch binding machine according to claim 3, characterized in that the front end of the said needle box (5) is provided with a needle outlet (51), and the bottom of the said needle outlet (51) is provided with a needle pressing head (53). A spring (52) is arranged between the lower surface of the said needle box (5) and the said frame (4), and the rear end of the said needle box (5) is hinged with the said frame (4). The said forming anvil (15) of the clamping device (1) is matched with the needle outlet (51).

8. The small enclosure-type branch binding machine according to claim 1, characterized in that the said handle (3) is composed of a handle skeleton (31) and a plastic grip (32), and the said handle skeleton (31) is embedded in the said plastic grip (32).

9. The small enclosure-type branch binding machine according to claim 8, characterized in that a silica gel anti-slip pad is arranged on the upper surface of the said plastic grip (32).

10. The small enclosure-type branch binding machine according to claim 8, characterized in that a first pin (71) is arranged at the rear part of the said frame (4), and a third pin (73) is arranged in the middle part of the said frame (4). The bottom of the said bow-
shaped frame (2) is hinged with the frame (4) through the said first pin (71); a second pin (72) is arranged in the middle part of the said bow-shaped frame (2), and the upper part of the said handle skeleton (31) is hinged with the said bow-shaped frame (2) through the second pin (72). A first hook body (311) is arranged at the lower end of the said handle skeleton (31), and the said first hook body (311) is sleeved on the outer circumference of the said third pin (73).
